(19) United States
(12) Patent Application Publication
(10) Pub. No.: US 2008/0259304 A1
(43) Pub. Date: Oct. 23, 2008

(54) Lithographic apparatus and method

(75) Inventor: Marcel Mathijs Theodore Marie Dierichs, Venlo (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/785,907

(22) Filed: Apr. 20, 2007

(51) Int. Cl. G03B 27/54

(52) U.S. Cl. 355/67

(57) ABSTRACT

A lithographic apparatus includes an illumination system to provide a beam of radiation; a support structure to support a patterning device, the patterning device serving to impart the radiation beam with a pattern in its cross-section; a substrate table to hold a substrate; and a projection system to project the patterned radiation beam onto a target portion of the substrate. The illumination system includes a first spatial light modulator including a first array of individually controllable elements controllable to control the field size of the radiation beam, the field position of the radiation beam or the uniformity of the radiation beam, and a second spatial light modulator arranged to apply a desired angular distribution to the radiation beam.

### FIELD

The present invention relates to a lithographic apparatus and method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. including part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion at once, and so-called scanners, in which each target portion is irradiated by scanning the pattern through the beam in a given direction (the “scanning”-direction) while synchronously scanning the substrate parallel or anti-parallel to this direction.

The intensity of a radiation beam is determined by its field size, which is effectively the degree to which the radiation beam extends across an object which it is incident upon. In a conventional lithographic apparatus, the radiation beam provided by a radiation source may be so intense (for example, due to the field size being so small) that, unless it is expanded using, for example, an array of small lenses, it may damage parts of the lithographic apparatus which it is incident upon. However, the use of an array of small lenses may not be a very flexible way of expanding the radiation beam and increasing its field size. In other situations, the radiation beam may be expanded to the maximum field size. If the field size is small, parts of the radiation beam may not be used, and will therefore be wasted.

### SUMMARY

It is desirable to provide, for example, a lithographic apparatus and method which obviate or mitigate one or more of the problems of the prior art, whether identified herein or elsewhere.

According to an embodiment of the invention, there is provided a lithographic apparatus including: an illumination system configured to provide a beam of radiation; a support structure configured to support a patterning device, the patterning device serving to impart the radiation beam with a pattern in its cross-section; a substrate table configured to hold a substrate; and a projection system configured to project the patterned radiation beam onto a target portion of the substrate, wherein the illumination system includes: a first spatial light modulator including a first array of individually controllable elements controllable to control the field size of the radiation beam, the field position of the radiation beam or the uniformity of the radiation beam; and a second spatial light modulator arranged to apply a desired angular distribution to the radiation beam.

According to an embodiment of the invention, there is provided an illumination system for a lithographic apparatus, the illumination system including: a first spatial light modulator including a first array of individually controllable elements controllable to control the field size of the radiation beam, the field position of the radiation beam or the uniformity of the radiation beam; and a second spatial light modulator arranged to apply a desired angular distribution to the radiation beam.

According to an embodiment of the invention, there is provided a lithographic method including: providing a substrate; providing a beam of radiation using an illumination system; using a patterning device to impart the radiation beam with a pattern in its cross-section; and projecting the patterned radiation beam onto a target portion of the substrate, wherein the provision of the radiation beam using the illumination system includes: controlling the field size of the radiation beam, the field position of the radiation beam or the uniformity of the radiation beam using a first spatial light modulator including a first array of individually controllable elements controllable to control the field size of the radiation beam, the field position of the radiation beam or the uniformity of the radiation beam; and applying a desired angular distribution to the radiation beam using a second spatial light modulator.

According to an embodiment of the invention, there is provided a method of affecting properties of a radiation beam, the method including: controlling the field size of the radiation beam, the field position of the radiation beam or the uniformity of the radiation beam using a first spatial light modulator including a first array of individually controllable elements controllable to control the field size of the radiation beam, the field position of the radiation beam or the uniformity of the radiation beam; and applying a desired angular distribution to the radiation beam using a second spatial light modulator.

According to an embodiment of the present invention, there is provided a lithographic apparatus including: an illumination system configured to provide a beam of radiation; a support structure configured to support a patterning device, the patterning device serving to impart the radiation beam with a pattern in its cross-section; a substrate table configured to hold a substrate; and a projection system configured to project the patterned radiation beam onto a target portion of the substrate, wherein the illumination system includes: a first spatial light modulator arranged to control the field size of the radiation beam, the field position of the radiation beam or the uniformity of the radiation beam; an exchange mechanism configured to change the first spatial light modulator for another spatial light modulator arranged to control the field size of the radiation beam, the field position of the radiation beam or the uniformity of the radiation beam; and a second spatial light modulator arranged to apply a desired angular distribution to the radiation beam.

According to an embodiment of the present invention, there is provided an illumination system for a lithographic apparatus, the illumination system including: a first spatial light modulator arranged to determine the field size of the radiation beam, the field position of the radiation beam or the uniformity of the radiation beam; an exchange mechanism configured to change the first spatial light modulator for another spatial light modulator arranged to determine the field size of the radiation beam, the field position of the radiation beam or the uniformity of the radiation beam; and a second spatial light modulator arranged to apply a desired angular distribution to the radiation beam.

According to an embodiment of the present invention, there is provided a lithographic method including: providing a substrate; providing a beam of radiation using an illumination system; using a patterning device to impart the radiation beam with a pattern in its cross-section; and projecting the patterned radiation beam onto a target portion of the substrate, wherein the provision of the radiation beam using the illumination system includes: changing the field size of the radiation beam, the field position of the radiation beam or the uniformity of the radiation beam by exchanging a first spatial light modulator arranged to control the field size of the radiation beam, the field position of the radiation beam or the uniformity of the radiation beam with another spatial light modulator arranged to control the field size of the radiation beam, the field position of the radiation beam or the uniformity of the radiation beam, and applying a desired angular distribution to the radiation beam using a second spatial light modulator.

According to an embodiment of the present invention, there is provided a method of affecting properties of a radiation beam, the method including: changing the field size of the radiation beam, the field position of the radiation beam or the uniformity of the radiation beam by exchanging a first spatial light modulator arranged to control the field size of the radiation beam, the field position of the radiation beam or the uniformity of the radiation beam with another spatial light modulator arranged to control the field size of the radiation beam, the field position of the radiation beam or the uniformity of the radiation beam, and applying a desired angular distribution to the radiation beam using a second spatial light modulator.

According to an embodiment of the invention, there is provided a lithographic apparatus including an illumination system configured to provide a radiation beam, the illumination system including a first spatial light modulator including individually controllable elements controllable to control a field size of the radiation beam, a field position of the radiation beam or a uniformity of the radiation beam, or any combination thereof; and a second spatial light modulator arranged to apply a desired angular distribution to the radiation beam; a support structure configured to support a patterning device, the patterning device serving to impart the radiation beam with a pattern in its cross-section; a substrate table configured to hold a substrate; and a projection system configured to project the patterned radiation beam onto a target portion of the substrate.

### BRIEF DESCRIPTION OF THE DRAWINGS

Embodiments of the invention will now be described, by way of example only, with reference to the accompanying schematic Figures in which corresponding reference symbols indicate corresponding parts, and in which:

FIG. 1 depicts a lithographic apparatus according to an embodiment of the invention;

FIGS. 2a and 2b depict a part of the lithographic apparatus in accordance with an embodiment of the invention;

FIGS. 3 to 8 depict uses of the apparatus of FIGS. 2a and 2b in accordance with embodiments of the invention; and

FIG. 9 depicts an illumination system according to another embodiment of the present invention.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

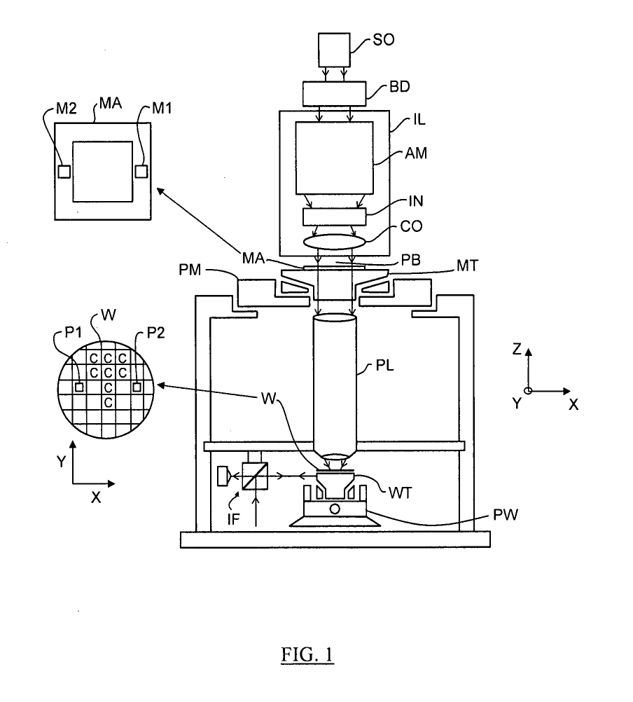

FIG. 1 schematically depicts a lithographic apparatus according to a particular embodiment of the invention. The apparatus includes an illumination system (illuminator) IL to condition a beam PB of radiation (e.g. UV radiation or DUV radiation); a support structure (e.g. a support structure) MT to support a patterning device (e.g. a mask) MA and connected to first positioning device PM to accurately position the patterning device with respect to item PL; a substrate table (e.g. a wafer table) WT configured to hold a substrate (e.g. a resist-coated wafer) W and connected to second positioning device PW configured to accurately position the substrate with respect to item PL; and a projection system (e.g. a refractive projection lens) PL configured to image a pattern imparted to the radiation beam PB by patterning device MA onto a target portion C (e.g. including one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including for example suitable directing mirrors and/or a beam expander. In other cases the source may be an integral part of the apparatus, for example when the source is a mercury lamp. The source SO and the illuminator IL, together with the beam delivery system BD if required, may be referred to as a radiation system. The beam delivery system BD may form part of the illuminator IL.

The illuminator IL may include an adjuster AM configured to adjust the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally includes various other components, such as an integrator IN and a condenser CO. The illuminator provides a conditioned beam of radiation PB, having a desired uniformity and intensity distribution in its cross-section.

The radiation beam PB is incident on the patterning device (e.g. mask) MA, which is held on the support structure MT. Having traversed the patterning device MA, the beam PB passes through the lens PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in the following preferred modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

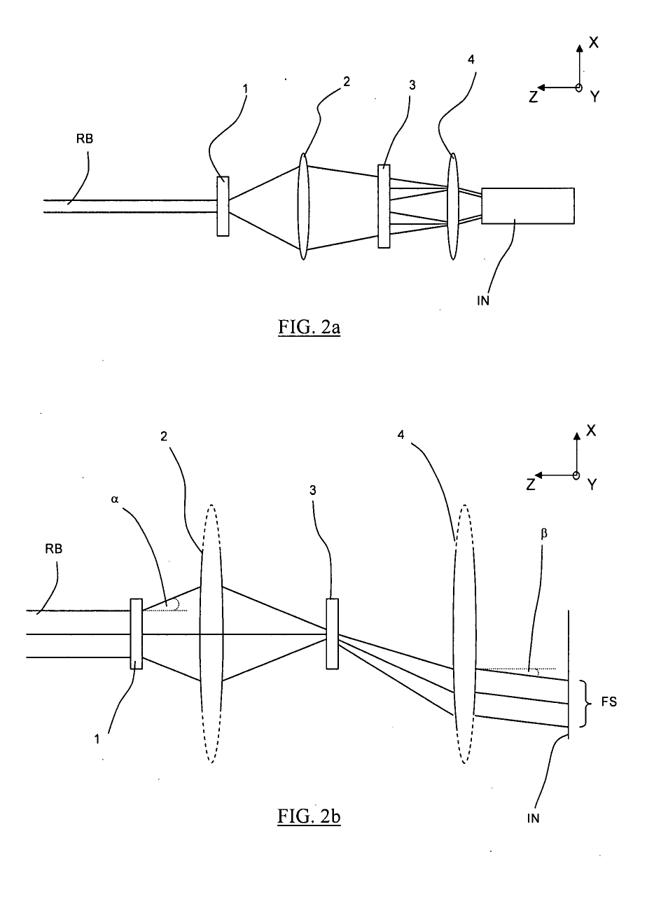

FIG. 2a schematically depicts the beam delivery system BD and part of the illuminator IL of FIG. 1 in more detail. A beam of radiation RB which is neither diverging nor converging (e.g. a radiation beam emitted from a laser source) is incident upon a first spatial light modulator 1 which includes a plurality of individually controllable elements. The first spatial light modulator 1 causes the radiation beam RB to diverge (in other words the radiation beam is expanded). A first lens 2 then directs the radiation beam RB toward a second spatial light modulator 3. The second spatial light modulator 3 is arranged to apply a desired angular distribution to the radiation beam RB. For example, the angular distribution of the radiation beam may be altered to provide a disc shape in a pupil plane or a dipole shape in a pupil plane. The radiation beam RB then passes through a second lens 4 and onto the integrator IN, which homogenizes the radiation beam.

The first spatial light modulator 1 is arranged to define the field size of the radiation beam. That is, the first spatial light modulator 1 is arranged to define the extent to which the radiation beam RB extends across an object upon which it is incident (for example, the integrator IN). The second spatial light modulator 3 is arranged to apply a desired angular distribution to the radiation beam RB. The operation of both the first spatial light modulator 1 and the second spatial light modulator 3 is described in more detail in relation to FIG. 2b.

FIG. 2b describes how a part of the radiation beam RB is affected by the first spatial light modulator 1 and the second spatial light modulator 3. It can be seen that a part of the radiation beam RB (which is neither diverging nor converging) is directed towards a part of the first spatial light modulator 1. The first spatial light modulator 1 introduces a divergence in the part of the radiation beam RB. The degree of divergence is denoted by the angle ‘α’ in FIG. 2b. The part of the radiation beam RB is then directed towards a part of the second spatial light modulator 3 by a part of the first lens 2. The second spatial light modulator 3 introduces a desired angular intensity distribution into the radiation beam RB by directing parts of the radiation beam RB in certain directions. The directed part of the radiation beam RB is then directed towards, for example, the integrator IN by a lens 4. The angle at which the part of the radiation beam RB is incident upon, for example, the integrator IN is located by the angle ‘β’ in the Figure. The angle β is determined by the properties of the part of the second spatial light modulator 3 (for example its position, orientation or the nature of the material which the part of the radiation beam RB is incident upon). The field size FS (that is, the extent to which the radiation beam RB or part of the radiation beam RB extend across a surface which it is incident upon, for example the integrator IN) is proportional to the angular divergence α introduced into the radiation beam RB by the first spatial light modulator 1.

The field size FS can be controlled by varying the angular divergence α of the radiation beam introduced by the first spatial light modulator 1. This can be achieved by appropriate control of the orientation and/or position of the elements of the array of individual elements which constitute the first spatial light modulator 1. Depending on the desired application, any suitable elements may be used in the first array of individually controllable elements. For example, the elements may be refractive (e.g. lenses), reflective (e.g. mirrors), or diffractive (e.g. a moveable grating of some sort). By giving the radiation beam RB which is provided by the radiation source SO (as shown in FIG. 1) a degree of divergence, the field size is increased which means that the radiation beam may not be so intense as to damage the elements of the lithographic apparatus which is incident upon (e.g. the integrator IN). Furthermore, in causing the radiation beam to diverge, a degree of homogeneity (or, in other words, uniformity) may be introduced into the radiation beam which may eliminate the need for the integrator IN. In other applications, the orientation and/or position of the elements of the array of individual elements which constitute the first spatial light modulator 1 may be changed to reduce the field size of the radiation beam (by, for example, causing the radiation beam RB to converge). In this way, the intensity of the radiation beam RB could be increased. In an embodiment, the first spatial light modulator arranged to control the field size of the radiation beam and/or the field position of the radiation beam and/or the uniformity of the radiation beam.

The angular intensity distribution introduced into the radiation beam RB by the second spatial light modulator 3 may be fixed. For example, a diffractive optical element (or refractive or holographic optical element) may be used as the second spatial light modulator 3 to ensure that, for example, a dipole shape is introduced into the pupil plane of the radiation beam RB. However, by providing a second spatial light modulator 3 which includes an array of individually controllable elements, the control of the angular intensity distribution of the radiation beam RB is more flexible. For example, the angular intensity distribution of the radiation beam RB may be easily changed by changing the orientation and/or position of elements within the array of individually controllable elements. The elements may be refractive (e.g. lenses), reflective (e.g. mirrors), or diffractive (e.g. a moveable grating of some sort).

The first spatial light modulator 1 which defines the field size of the radiation beam may define the field size in one or two spatial dimensions (for example in the directions X and Y as shown in FIGS. 2a and 2b). Controlling the field size of the radiation beam RB in one or two dimensions may be achieved by appropriate control of the position and/or orientation of elements within the array of individually controllable elements which constitute the first spatial light modulator 1.

It will be appreciated that the field size of the radiation beam can be controlled at any appropriate position in the lithographic apparatus, for example at the level of the substrate or patterning device. As mentioned previously, the field size at a particular point can be changed by changing the position and/or orientation of the elements within the array of individually controllable elements which define the first spatial light modulator 1.

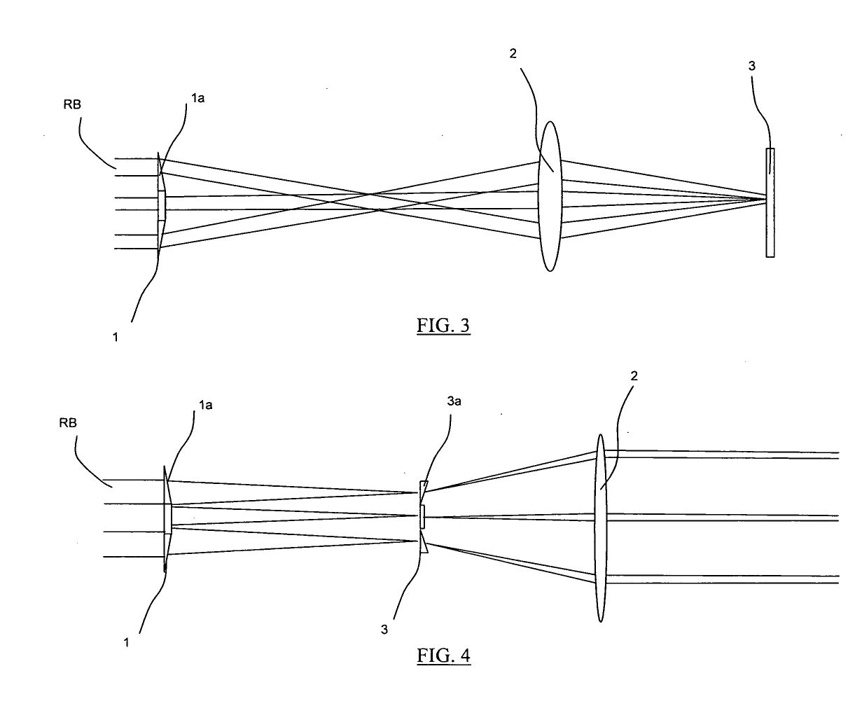

As well as controlling the field size, the position and/or orientation of the elements within the array of individually controllable elements which define the first spatial light modulator 1 can be controlled to affect what parts of the radiation beam RB are incident on specific parts of the second spatial light modulator 3. This may be useful when introducing a desired angular intensity distribution into the radiation beam RB using the second spatial light modulator 3. These and other benefits are described in relation to FIGS. 3 to 8.

FIG. 3 shows that elements of the first spatial light modulator 1 can be configured such that it mixes (or in other words homogenizes) component parts of the radiation beam RB. For example, component parts of the radiation beam RB can be made to, at first, converge to mix the component parts of the radiation beam RB. If such mixing is undertaken, it may not be necessary to use an integrator to mix and therefore control the uniformity of the radiation beam RB.

In some circumstances, it may be desirable to ensure that the angular distribution of radiation incident on the second spatial light modulator is small compared to the angle introduced to specific parts of the radiation beam by the second spatial light modulator. FIG. 4 shows how this may be achieved. The first spatial light modulator 1 is configured such that specific elements la of the first spatial light modulator 1 direct and focus parts of the radiation beam onto specific parts 3a of the second spatial light modulator 3. It can be seen that the angular distribution of radiation incident on the second spatial light modulator 3 is small compared to the angle introduced to specific parts of the radiation beam by the second spatial light modulator 3.

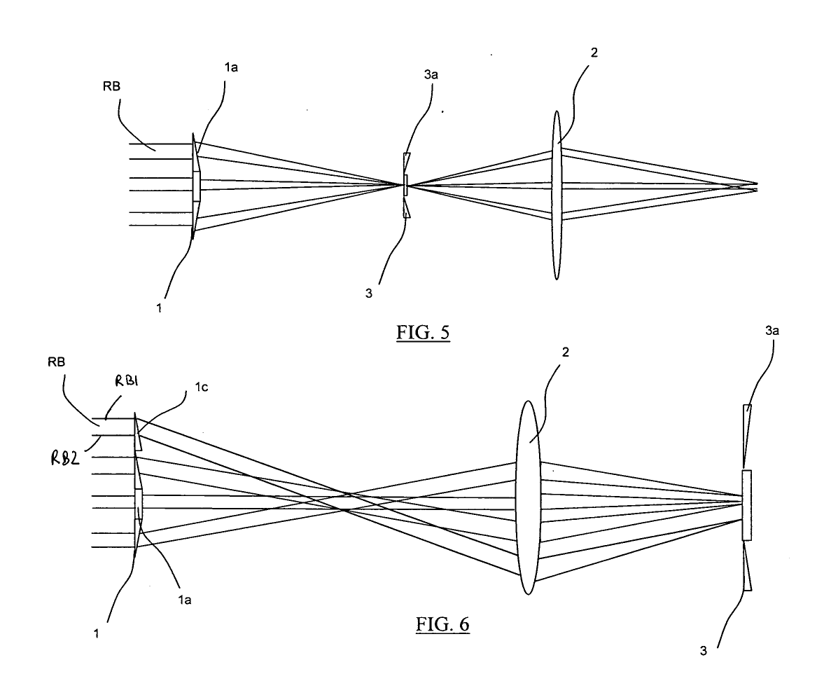

FIG. 5 shows that it is not necessary to use all parts 3a which make up the second spatial light modulator 3. Instead, radiation can be directed by the parts 1a of the first spatial light modulator 1 onto one or a selected number of parts 3a of the second spatial light modulator 3. Different parts 3a of the second spatial light modulator 3 may be configured to introduce different angular intensity distributions into the radiation beam, and it may well be that only one or more of these angular intensity distributions are desired. The regions of the one or more parts 3a of the second spatial light modulator 3, which introduce a desired angular intensity distribution into the radiation beam (e.g. slits, if the second spatial light modulator 3 is diffractive in nature), should be large enough to receive the radiation directed onto them by the parts 1a of the first spatial light modulator 1.

If, for example, only a certain number of elements of the first spatial light modulator 1 are required to introduce a certain field size, light incident on the other mirrors could be wasted. However, since in an embodiment of the present invention the elements of the first spatial light modulator 1 are individually controllable, the elements which are not required to determine the field size can re-direct parts of the radiation beam RB toward the second spatial light modular 3 instead of, for example, reflecting them away. The parts of the radiation beam RB which would otherwise have been reflected away can now contribute to the intensity of the field of the radiation beam RB, instead of being wasted.

FIG. 6 shows that the parts 1a of the first spatial light modulator 1 may be configured to reduced the field size of the radiation beam RB by causing it to converge. Different parts of the radiation beam can be directed in slightly different directions. For example, different parts of the radiation beam can be directed in slightly different directions to ensure that certain parts of the radiation beam RB are incident upon the second spatial light 3 modulator at the same angle, or at different positions on one or more parts 3a of the second spatial light modulator 3. Such directing may be used to control the final field position of parts of the radiation beam RB whose angular intensity distribution is controlled by the second spatial light modulator. It can be seen in FIG. 6 that one part 1c of the first spatial light modulator 1 has been configured to ensure that two components RB1, RB2 of the radiation beam are incident upon the second spatial light modulator 3 at the same angle. This means that the field position of these components RB1, RB2 will be the same. As mentioned in relation to FIG. 5, the parts of the radiation beam RB not needed to make up a desired field size can be redirected toward the second spatial light modulator 3 to increase the intensity of the field. Referring back to FIG. 6, it will now be appreciated that these redirected parts maybe directed such that there angles of incidence upon the second spatial light modulator 3 are the same, so as not to affect their position in the field.

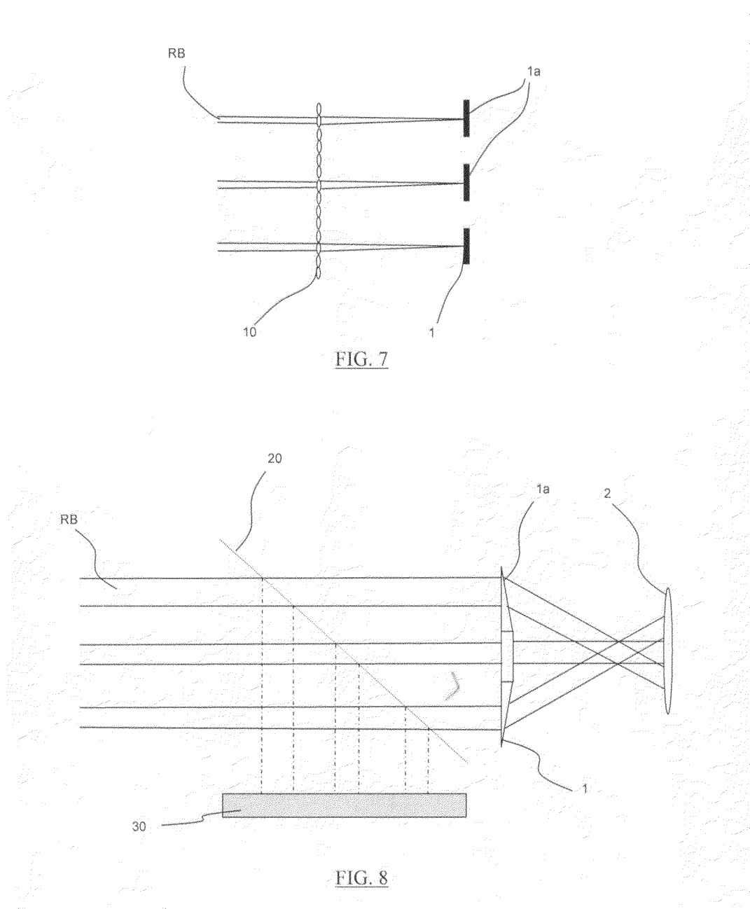

The first spatial light modulator includes an array of individually controllable elements. In between those elements there may be spaces which will not reflect, refract or diffract the radiation beam as required. FIG. 7 shows how this problem may be overcome. A refractive optical element 10, for example, may be positioned before the first spatial light modulator 1 to ensure that parts of the radiation beam RB are only incident upon the individually controllable elements 1a of first spatial light modulator 1, and not at spaces in-between the element 1a. The refractive optical element 10 may be fixed in position relative to the individually controllable elements 1a of first spatial light modulator 1, or be moveable to be brought into alignment with those elements 1a. Conversely, the first spatial light modulator 1 may be fixed in position relative to the refractive optical element 10, or be moveable to be brought into alignment with the refractive optical element 10.

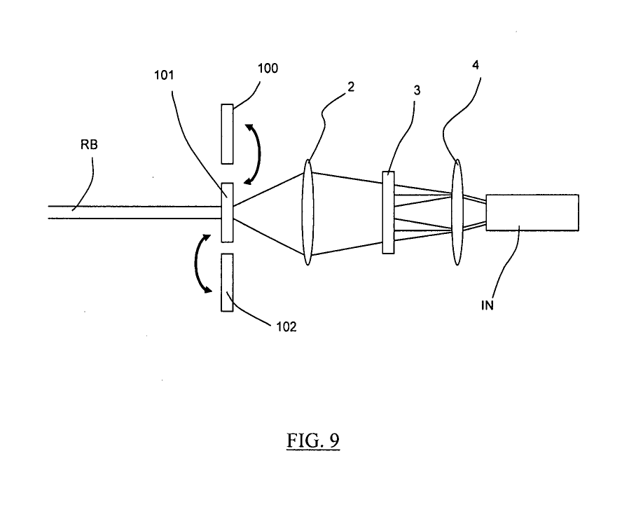

FIG. 8 illustrates a method of monitoring the uniformity of the radiation beam RB and its position relative to the first spatial light modulator 1. A partially reflecting mirror 20 is used to reflect a part of the radiation beam RB to a CCD camera 30. The camera 30 can be used to monitor the position of the radiation beam, ensuring that the parts of the first spatial light modulator 1 that upon which the radiation beam RB is incident does not change. The camera 30 may also be used to monitor the uniformity of the radiation beam RB. If the uniformity changes, the position and/or orientation of parts 1a of the first spatial light modulator 1 may be changed to mix (or in other words homogenize) the radiation beam such that it is uniform, as described above. Such changing may be undertaken in real time.

In the above embodiments, the first spatial light modulator 1 has been described as including an array of individually controllable elements controllable to change the field size of the radiation beam. FIG. 9 shows that according to a different embodiment of the present invention, instead of using a controllable array of elements, a plurality of interchangeable but fixed field defining elements (i.e. first spatial light modulators) 100, 101, 102 could be used. Various different field defining elements could be loaded into an exchange mechanism, which could, upon command, change the field defining element located in the path of the radiation beam. The field defining element could then be changed between successive exposures, or sets of exposures, to determine the field size for the next exposures or set of exposures. All of the functional principles discussed in relation to the spatial light modulator 1 of FIGS. 2 to 8 apply to the fixed, but interchangeable spatial light modulators 100, 101, 102 of FIG. 9. However, instead of changing the position or orientation of constituent parts of the spatial light modulator to achieve different functionality, the spatial light modulator is changed for another with the desired functionality.

As well as, or instead of controlling the field size of the radiation beam RV, the field position of the radiation beam can be controlled by appropriate control of the array of individually controllable elements which makeup the first spatial light modulator 1. The field position may be controlled to locate the field at a preferred part of a lens or other part of the lithographic apparatus (for example the second spatial light modulator 3). The field position may be controlled in one or two dimensions using the array of individually controllable elements which define the first spatial light modulator 1.

It will be appreciated that a diffuser may be added to the embodiments described above in order to reduce or eliminate any discretization of the radiation beam RB by the first spatial light modulator 1 and/or second spatial light modulator 3.

FIGS. 2 to 9 schematically depict the first spatial light modulator 1 and second spatial light modulator 3 as being refractive in nature. However, and as mentioned above, the first spatial light modulator 1 and second spatial light modulator 3 may be refractive, reflective, or diffractive in nature.

In the embodiments described above, the radiation beam RB is incident upon the first spatial light modulator before it is incident upon the second spatial light modulator. However, the radiation beam RB may be incident upon the second spatial light modulator before it is incident upon the first spatial light modulator. It may be preferred to ensure that the radiation beam is incident on the first spatial light modulator before it is incident on the second spatial light modulator to reduce discretization effects, etc. on the radiation beam.

While specific embodiments of the invention have been described above, it will be appreciated that the invention may be practiced otherwise than as described. The description is not intended to limit the invention, the invention being defined by the claims that follow.

1. A lithographic apparatus comprising:
an illumination system configured to provide a radiation beam, the illumination system including
a first spatial light modulator comprising individually controllable elements controllable to control a field size of the radiation beam, a field position of the radiation beam or a uniformity of the radiation beam, or any combination thereof; and
a second spatial light modulator arranged to apply a desired angular distribution to the radiation beam;
a support structure configured to support a patterning device, the patterning device serving to impart the radiation beam with a pattern in its cross-section;
a substrate table configured to hold a substrate; and
a projection system configured to project the patterned radiation beam onto a target portion of the substrate.

2. The lithographic apparatus of claim 1, wherein the first spatial light modulator and the second spatial light modulator are positioned such that the radiation beam is incident upon the first spatial modulator before it is incident upon the second spatial modulator.

3. The lithographic apparatus of claim 1, wherein the individually controllable elements comprise an array arranged to reflect, refract or deflect at least a part of the radiation beam to control the field size of the radiation beam, the field position of the radiation beam or the uniformity of the radiation beam.

4. The lithographic apparatus of claim 1, wherein the second spatial light modulator is a diffractive optical element, a refractive optical element or a holographic optical element.

5. The lithographic apparatus of claim 1, wherein the second spatial light modulator comprises an array of individually controllable elements controllable to control the angular distribution of the radiation beam.

6. The lithographic apparatus of claim 5, wherein the elements of the array of individually controllable elements are arranged to reflect, refract or deflect at least a part of the radiation beam to control the angular distribution of the radiation beam.

7. The lithographic apparatus of claim 1, wherein the radiation beam is provided by a laser.

8. The lithographic apparatus of claim 1, further comprising a radiation source, the radiation source being a laser.

9. A lithographic method comprising:
providing a beam of radiation using an illumination system;
imparting the radiation beam with a pattern in its cross-section; and
projecting the patterned radiation beam onto a target portion of a substrate,
wherein providing the radiation beam using the illumination system comprises:
controlling a field size of the radiation beam, a field position of the radiation beam or a uniformity of the radiation beam or any combination thereof by using a first spatial light modulator comprising individually controllable elements; and
applying a desired angular distribution to the radiation beam using a second spatial light modulator.

10. The lithographic method of claim 9, wherein the radiation beam is incident upon the first spatial light modulator before it is incident upon the second spatial light modulator.

11. The lithographic method of claim 9, further comprising changing a position and/or orientation of an array of the elements within the individually controllable elements to control the field size of the radiation beam, the field position of the radiation beam or the uniformity of the radiation beam.

12. The lithographic method of claim 9, wherein the second spatial light modulator comprises an array of individually controllable elements controllable to control the angular distribution of the radiation beam.

13. The lithographic method of claim 12, further comprising changing a position and/or orientation of one or more elements of the array of individually controllable elements to change the angular distribution of the radiation beam.

14. The lithographic method of claim 9, further comprising controlling the field size or field position in one dimension.

15. The lithographic method of claim 9, further comprising controlling the field size or field position in two dimensions.

16. The lithographic method of claim 9, wherein the radiation beam is provided by a laser.

17. A lithographic apparatus comprising:
an illumination system configured to provide a radiation beam, the illumination system including
a first spatial light modulator arranged to control a field size of the radiation beam, a field position of the radiation beam or a uniformity of the radiation beam or any combination thereof;
an exchange mechanism configured to change the first spatial light modulator for another spatial light modulator arranged to control the field size of the radiation beam, the field position of the radiation beam or the uniformity of the radiation beam; and
a second spatial light modulator arranged to apply a desired angular distribution to the radiation beam;
a support structure configured to support a patterning device, the patterning device serving to impart the radiation beam with a pattern in its cross-section;
a substrate table configured to hold a substrate; and
a projection system configured to project the patterned radiation beam onto a target portion of the substrate.
